(19) United States
(12) Patent Application Publication
(10) Pub. No.: US 2009/0220914 A1
(43) Pub. Date: Sep. 3, 2009

(54) DENTAL IMPLANT AND A METHOD OF IMPLANTATION THEREOF

(75) Inventor: Afraim GERSHENZON, Bat Yam (IL)

Correspondence Address: BROWDY AND NEIMARK, P.L.L.C.;624 NINTH STREET, NW, SUITE 300, WASHINGTON, DC, 20001-5303, US

(73) Assignees: Dental- Li Uri Consulting 2007 Ltd., Ness-Tziona (IL); PC Content Ltd., Bat Yam (IL)

(21) Appl. No.: 12/102,126

(22) Filed: Apr. 14, 2008

Related U.S. Application Data
(60) Provisional application No. 61/064,331, filed on Feb. 28, 2008.

(51) Int. Cl. A61C 8/00

(52) U.S. Cl. 433/174

(57) ABSTRACT

A dental implant is presented comprising a sharp threaded shaft operative as an active guiding engagement portion and having a sharp tip portion at its distal end. The sharp tip portion operates as an engaging member to cut through the bone and to define a path to the implant, and the sharp threads facilitate the non-surgical insertion.

### FIELD OF THE INVENTION

This invention is generally in the field of tooth prostheses and relates to dental implants and a method of implantation of dental implants into bone useful in both prosthodontic and orthodontic applications.

### BACKGROUND OF THE INVENTION

Dental implants are conventionally intended to substitute missing tooth in the upper jaw, called “maxilla” or in the lower jaw, called “mandible”. Dental implants are inserted into the bone of the jaw and have a portion protruding through the mucous gum tissue for providing attachment anchorage for artificial teeth. An artificial tooth may be attached directly to the implant, or to an abutment connected to the implant.

Usually the dental implants comprise at least three distinct components: an intra-osseous component, the supra-osseous component called the abutment, and a screw which combines the first and the second part. The intra-osseous element is shaped as a tapered cylinder having a flat threaded surface. The surface of the intra-osseous element is either sand blasted, acid worked or plated with materials considered favorable for bone grow such as hydroxyapatite. At the upper portion of the intra-osseous element, a polygonal shaped entrance or prominence is provided for the connection with the abutment. The general form of the intra-osseous element mimics the form of natural tooth roots for improved absorption of the forces of mastication.

The intra-osseous element is typically inserted into the bone by surgical means of incision of the periosteum and drilling into the jaw bone by a sequence of special drills until a proper form is created. Then, the intra-osseous element is inserted either by screwing or by tapping into the jaw. The site is sutured over and left for three to six months for achieving bone grow around the intra-osseous element.

The abutment has a cylindrical or angular form with a connecting part at the lower end matching that of the intra-osseous element, and with tunnel at the upper end for the screw connecting the two components.

These devices are traditionally crafted from metallic alloys based on titanium, but lately zirconium components are experiments with different grade of success. A typical implant consists of a titanium screw, with a roughened surface. This surface is treated either by plasma spraying, etching or sandblasting to increase the integration potential of the implant.

At edentulous jaw sites, a hole is bored into the recipient bone, taking care to avoid vital structures, in particular the inferior alveolar nerve within the mandible. This hole is then expanded by using progressively wider drills. A cooling saline spray keeps the temperature of the bone to below 47° C.

There are three major types of dental implants: press-fit; self-tapping; and pre-tapping. The press-fit type implants are inserted into holes drilled into the bone without rotation. Unfortunately, press-fit implants do not couple tightly to the soft bone of the maxilla. Self-tapping and pre-tapping type implants have horizontal threads for being screwed into holes drilled into the jaw-bone, for better mechanical coupling to the jaw bone. Self-tapping implants create grooves in the hole as the implant is screwed in. Prior to the insertion of pre-tapped implants, a tool is used to form threads in the hole. While screwing, self-tapping and pre-tapping implants into the bone generally improves the mechanical coupling between the implant and bone, it has been found that in the soft bone of the maxilla, the rotation of both the self-tapping and pre-tapping implants may destroy the grooves, preventing tight coupling between the implant and the bone.

After insertion of the implant, a sufficient period of time must be given for the tissue to heal and for the bone to grow around the implant for the dental implant to become securely engaged in the jaw. This typically requires about three months. An artificial tooth is then attached to the implant, directly or by attachment to an abutment attached to the implant.

An increasingly common strategy to preserve bone and reduce treatment times includes the placement of a dental implant into a recent extraction site. In addition, immediate loading is becoming more common as success rates for this procedure are now acceptable. This can cut months off of the treatment time and in some cases a prosthetic tooth can be attached to the implants at the same time as the surgery to place the dental implants.

There are two general classifications of bone: trabecular and cortical. Cortical bone is a dense, hard, and stiff material that makes up the outer surface of bones while trabecular bone is a porous and softer material that makes up the inner core of the bone. Because conventional implants are threaded into the trabecular bone through a hole drilled through the cortical bone, much of the load is transferred from the prosthetic tooth, through the implant, and to the surface between the implant and the trabecular bone. Unfortunately, trabecular bone may not have adequate thickness and strength to keep micro movements below the required level before the two surfaces have grown together.

Dental implants have been used in the hard bone of the mandible with great success. The maxilla bone, however, is very soft and porous and it is common for dental implants in the maxilla to lack stability.

### General Description

There is a need in the art in providing a dental implant configured to enable its insertion into a jaw bone of a patient (maxilla or mandible) in a non-surgical procedure, namely procedure carried out without a preliminary drilling of an opening in the bone for a further dental implant insertion. In other words, there is need in the art in a self-threading dental implant, which should preferably be a one-piece assembly, but may also be a more common multiple part assembly, and which is appropriately designed to form a cavity of a predetermined size within the bone portion.

A typical implant consists of a screw (resembling a tooth root) with a roughened surface. An osteotomy or precision hole is carefully drilled into jawbone and the implant is installed in the osteotomy. This procedure completely destructs the bone material drilled away. The present invention solves the above problem by providing a novel dental implant configured as a self threading dental implant for immediate restorations. The dental implant of the present invention includes a sharp threaded shaft operative as an active guiding engagement portion and having a sharp tip portion at its distal end (i.e. apical end). The sharp threaded shaft is appropriately designed to form a cavity of a predetermined size all along the shaft within the bone portion The sharp tip portion serves for maintaining the implantation direction, and the threaded shaft includes individually sharpened threads operating as cutting members to cut through the bone and to define a path to the implant in said direction. It should be noted that as the dental implant of the present invention advances in the bone, a cavity is formed within the bone portion preventing the bone destruction. Commonly used implants are configured as screws and are operable to drill into the bone, producing cylindrical holes in the bone. As performed in solid materials, under normal usage, swarf (i.e. the debris or waste resulting from drilling) is carried up and away from the tip of the drill bit by the fluting. The continued production of chips (shaving) from the cutting edges produces more chips which continue the movement of the chips outwards from the hole. This continues until the chips pack too tightly, either because of deeper than normal holes or insufficient backing off (removing the drill slightly or totally from the hole while drilling).

The present invention is intended to introduce the implant into the bone with minimal bone loss and without production of bone debris. Neither prior set of drilling is applied, nor the implant is used as drill of some kind. Due to the presence of individually threaded cutting members in the shaft, the in-bone space needed for the implant is created not by an effect of drilling but rather by lateral bone compression.

As the preliminary surgical step the exterior compact layer is removed in circular form to permit the initial implant engagement with the insertion site. Under the exterior compact layer the jaw bone comprises porous structure which in terms of the present invention is intended not to be drilled out—but to be condensed laterally and into the inter threads space. The pores of the bone collapse laterally gradually creating the space for the advancing self threading implant. The presence of porous space inside the jaws bone makes the implant of the present invention operable in that biological environment.

The bone compression capability of the implant of the present invention is based on inter threads compression, by using deep sharpened threads. In the present invention, much of the bone material is compressed and less bone is left to be excavated.

The implant of the present invention is configured for eliminating prior drilling keeping more bone to be compressed and spared.

Therefore the present invention provides a dental implant comprising a sharp threaded shaft operative as an active guiding engagement portion having a sharp tip portion at its distal end. The sharp tip portion operates as an engaging member to cut through the bone and to define a path to the implant; the dental implant being thereby configured as a self threading implant allowing immediate restorations.

Preferably, the sharp threaded shaft includes individually sharpened threads operating as cutting members located between the tip portion and the abutment of the implant; the threads are configured and operable to reduce bone debris production.

Preferably, the sharp threaded shaft is configured and operable to create lateral gradual bone compression.

Preferably, the sharp tip portion is integral with the sharp threaded shaft, the dental implant being a one-piece assembly.

According to some embodiments of the invention, the dental implant further includes a head portion at a proximal end of the sharp threaded shaft, the head portion being configured to enable engagement with a tool to operate the dental implant by the tool.

According to some embodiments of the invention, the dental implant further includes an abutment positioned between the sharp threaded shaft and the head portion.

According to yet another aspect of the invention there is provided a dental implant including a centering arrangement for positioning the implant at the center of a treatment site, the centering arrangement including a sharp tip portion at a distal end of a sharp threaded shaft presenting an active guiding engagement portion.

Preferably, the sharp threaded shaft is configured to engage with a jaw bone material being cut, thereby stabilizing the implant within the jaw bone.

According to yet another aspect of the invention there is provided a dental implant configured to be insertable in a thin bone.

According to yet another aspect of the invention, there is provided a method of inserting a dental implant into a jaw bone of a patient, the method including cutting the jaw bone material while threading the dental implant into the jaw bone region being cut, thereby enabling the jaw bone material being cut to engage with a sharp threaded shaft, the method thereby enabling insertion of the dental implant in a non-surgical procedure.

Preferably, the method enables at least one of the followings: positioning of the implant at the center of a treatment site in the jaw bone; positioning the implant at a predetermined angle with respect to the jaw bone; enabling in site reshaping of the dental implant for aligning it with an existing teeth or additional implants.

According to yet another aspect of the invention there is provided a method of inserting a dental implant into the maxilla of a patient, the method including cutting the maxilla material while threading the dental implant into the maxilla being cut, thereby enabling the maxilla material being cut to engage with a sharp threaded shaft the method, thereby enabling insertion of the dental implant in a non-surgical procedure.

According to yet another aspect of the invention there is provided a method of inserting a dental implant into a natural jaw bone of a patient, the method including: providing a dental implant as defined above; engaging a tool fitting the head of the dental implant; rotating the tool to insert the dental implant into the jaw bone of a patient.

Preferably, the method further includes attaching a prosthetic tooth to the dental implant involving immediate loading.

Preferably, the method further includes putting in correspondence the prosthetic axis with the local situation.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a simplified view of a dental implant according to the teachings of the present invention;

FIG. 2 is a more specified view of the same;

FIG. 3 is an enlarged perspective view of an active guiding engagement portion having a sharp tip portion at its distal end;

FIG. 4 is an upper cross section view of the head portion of the dental implant; and,

FIG. 5A is an enlarged perspective view of the apical side of the thread in conventional implants; and

FIG. 5B illustrates the sharp threaded shat having individually sharpened threads at the tap edge.

### DETAILED DESCRIPTION OF EMBODIMENTS

As previously discussed, the conventional techniques make use of surgical intervention. This causes multiple office visits and increased costs, increasing both the physical and financial discomfort to the patient. The present invention allows for avoiding surgery, and thus both the implants and the denture could be mounted in a single office visit, thereby reducing the cost and incidence of pain to the patient.

Moreover, because the inventive dental implant has a one-piece design, it is not susceptible to the microleakage problems on the bacteria and ionic levels, which were characteristic of the conventional multiple-piece designs. Accordingly, the inventive dental implant is less likely to be rejected by the patient, less likely to lead to infection, and less likely to corrode.

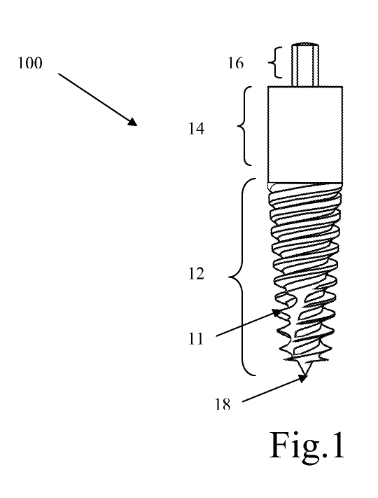

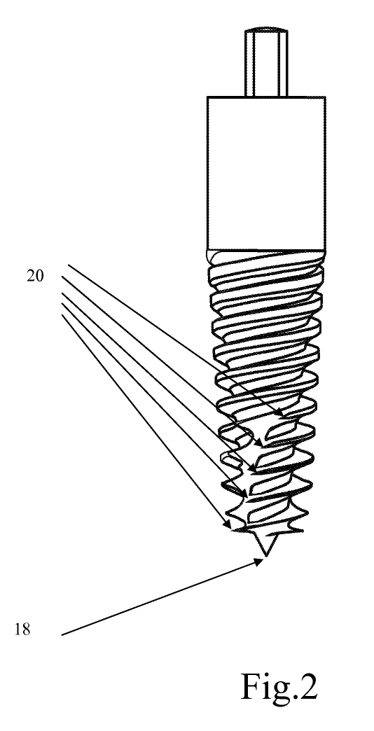

Reference is now made to FIG. 1 and FIG. 2, which are pictorial illustrations of a self-threading dental implant 100. Self-threading is the ability of the implant to advance when turned while creating its own engaging thread. Implant 100 includes a sharp threaded shaft 12 having a sharp tip portion 18 at its distal end to cut through the bone with minimal prior drilling and to define a path to implant 100. Sharp threaded shaft 12 is operative as an active guiding engagement portion (cutting portion), in which the cutting edges of the threaded shaft cut their own engaging threads as implant 100 is driven in to the jaw bone. Threaded shaft 12 compress the mucous gum tissue making a hole for implant 100 to go into. Therefore, implant 100 enables the penetration of sharp threaded shaft 12 into the normal jaw bone in a non-surgical method of insertion. Threaded shaft 12 may be configured as a double helix or a single helix including individually sharpened threads 20. As illustrated in FIG. 1, the cross section of the individually sharpened threads 20 is gradually wider. It should be noted that the sharp threaded shaft 12 and the extern outline of the implant have not the same width achieving a close contact between the bone and the implant surface.

Moreover, the threaded shaft 12 has a cutting portion 11 enabling the compression of the bone laterally and into the inter threads space.

Threaded shaft 12 may be cylindrical or conical. Implant 100 enables minimal and non drilling insertion techniques (eliminating drilling heat and reducing bone exposure to infection) leading to a minimal or none bone mass destruction, greater bone preservation on site and therefore is intended for immediate loading. Moreover, implant 100 creates an improved initial stability using a lateral bone compression connection between the living bone and the surface of implant 100, further facilitating the ulterior osseointegration.

Implant 100 further includes an abutment portion 14 and a head portion 16 configured to enable the engagement of a tool to operate implant 100 in the jawbone of a patient by the tool.

The sharp pointing tip 18 at the top of the implant 100 maintains the implantation direction. Threaded shaft 12 includes threads having individual threads sharpening 20 located in the in-bone part of the implant 100. The individual sharp threads 20 are not crushing the bone in process of advancing into it—but are creating gradual bone compression laterally and in the inter threads direction. The sharpening of all threads allows less forceful insertion which is less traumatic for the supporting bone. Bone compression improves the initial stability of the implant in the bone and allows the immediate loading of the implant by a prosthetic device.

It should be noted that once the implant is inserted inside the bone, its manual extraction is prevented by the close contact between the bone and the implant. Preferably, as illustrated in FIG. 2, sharp threaded shaft 12 has a cutting region 11 intended to collect the bone tissue into the inter-threads space.

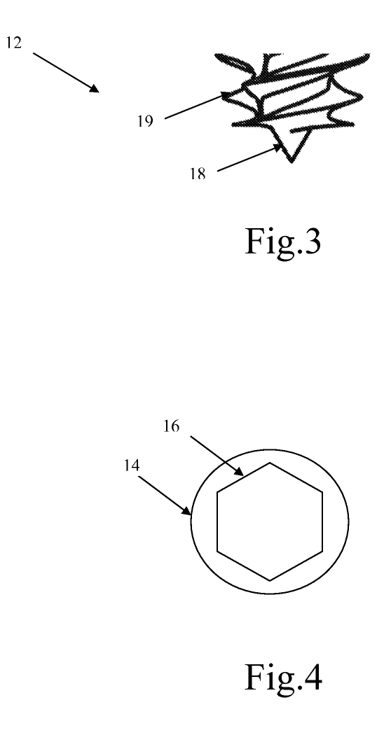

Reference is now made to FIG. 3, illustrating an enlarged perspective view of the active guiding engagement portion of sharp threaded shaft 12 at the distal end of implant 100. Sharp tip portion 18 operates as an engaging member to cut through the bone and to define a path to said implant. Sharp engaging threads 20 penetrate into the jaw bone and stabilize the implant within the jaw bone, improving the initial and long-term stability of the implant.

Preferably, as illustrated in FIG. 4, head portion 16 is shaped as multi-sided surfaces, suitable for receiving and engaging a tool for twisting, turning, holding or inserting implant (100 in FIG. 1) into the jawbone of a patient. Once head portion 16 is fitted with the tool, it will be possible to grasp the tool and to turn the tool to advance dental implant (100 in FIG. 1) into the bone, while exerting downward pressure on head portion 16 in the long axis of the implant.

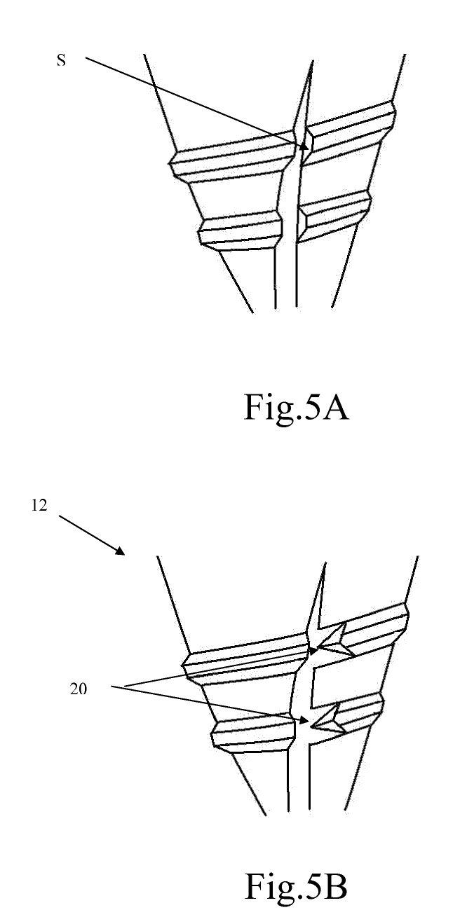

It should be noted that generally, the production of the implants includes creation of inter-threads taps which lead to the formation of a blunt face S as illustrated in FIG. 5A. This face opposes the implant rotation and makes non-drilled insertion more difficult.

In the proposed novel implant design, the blunt face S is completely eliminated due to the individually sharpened threads at the tap edge. In this connection, reference is made to FIG. 5B illustrating the individually sharpened threads 20. All the threads are sharpened and not only the apical one. This configuration greatly facilitates the self-tapping and further reduces the need for extensive drilling. The blunt surface S is thus eliminated and substituted by sharpened threads.

According to the present invention, the dimensions of the dental implant can be varied over a wide range. The limiting factor is the suitability of the implant in the non-surgical method described in the present application. Without intending to limit the scope of the invention in any manner, as other dimensions may well prove to be suitable in the non-surgical method described herein depending upon the materials employed and the intended use, and, especially for orthodontic applications, the inventive dental implant can range in overall length from about 9 mm to about 30 mm, preferably from about 23 mm to about 29 mm. The length of the sharp threaded shaft likewise can range from about 4 mm to about 20 mm, preferably from about 8 mm to about 17 mm; and the width of the thickest portion of the threaded shaft can range from 1-2 mm to about 5.0 mm, and is, preferably, about 3.5 mm.

Furthermore, conventional dental implants have the difficulty of carrying out a correction of axis in order to put in correspondence the prosthetic axis with the local situation. The axis of threaded shaft coincides or is angled according to the needs. The implant of the present invention is configured to enable in site reshaping for aligning with existing teeth or additional implants.

The method of insertion of the implant of the present invention is non-surgical in one stage only and hence a minimum physical trauma is involved. The insertion of the implant is performed almost without bleeding.

According to the teachings of the present invention, the implant of the present invention couples tightly to the soft bone of the maxilla.

According to one embodiment of the present invention, the implant of the present invention may be embedded into a thin bone, which barely exceeds the implant's diameter. For example, in the surgical intervention of sinus lifting, the dental surgeon thickens the adequate part of atrophic maxilla towards the sinus with the help of bone transplantation or bone expletive substance and as a result of it, the implantation is enabled.

According to another embodiment of the present invention, in case of moderate maxilla bone loss, the implant of the present invention may be anchored into the sinus floor therefore reducing the need of sinus augmentation. Bone replacement is necessary in case of lack of adequately thick bone, which could hold the implant.

Those skilled in the art will readily appreciate that various modifications and changes can be applied to the embodiments of the invention as hereinbefore described without departing from its scope defined in and by the appended claims.

1. A dental implant comprising a sharp threaded shaft operative as an active guiding engagement portion having a sharp tip portion at its distal end, said sharp tip portion operating as an engaging member to cut through the bone and to define a path to said implant, the dental implant being thereby configured as a self threading implant allowing immediate restorations.

2. The dental implant according to claim 1, wherein said sharp threaded shaft comprises individually sharpened threads operating as cutting members configured and operable to reduce bone debris production.

3. The dental implant according to claim 1, wherein said sharp threaded shaft is configured and operable to create lateral gradual bone compression.

4. The dental implant according to claim 1, wherein said sharp tip portion is integral with said threaded shaft, said dental implant being a one-piece assembly.

5. The dental implant according to claim 1, further comprising a head portion at a proximal end of said threaded shaft, the head portion being configured to enable engagement with a tool to operate said dental implant by said tool.

6. The dental implant according to claim 5, comprising an abutment positioned between said sharp threaded shaft and said head portion.

7. The dental implant according to claim 1, comprising a centering arrangement for positioning said implant at the center of a treatment site, said centering arrangement comprising a sharp tip portion.

8. The dental implant according to claim 1, wherein said sharp threaded shaft is configured to engage with a jaw bone material being cut thereby stabilizing said implant within the jaw bone.

9. The dental implant according to claim 1, configured to be insertable in a thin bone.

10. A dental implant including a centering arrangement for positioning the implant at the center of a treatment site, the centering arrangement comprising a sharp tip portion at a distal end of a sharp threaded shaft presenting an active guiding engagement portion.

11. A method of inserting a dental implant into a jaw bone of a patient, the method comprising cutting the jaw bone material while threading the dental implant into the jaw bone region being cut, thereby enabling the jaw bone material being cut to engage with a sharp threaded shaft, said method thereby enabling insertion of the dental implant in a non-surgical procedure.

12. The method of claim 11, wherein said cutting and threading are carried out by a dental implant comprising a sharp threaded shaft having a sharp tip portion at its distal end, said sharp tip portion operating as an engaging member to cut through the bone and to define a path to said implant, thereby enabling positioning of said implant at the center of a treatment site in the jaw bone.

13. The method of claim 11, wherein said cutting and threading are carried out by a one-piece dental implant comprising a sharp threaded shaft having a sharp tip portion at its distal end, said sharp tip portion operating as an engaging member to cut through the bone and to define a path to said implant, thereby enabling positioning said implant at a predetermined angle with respect to the jaw bone.

14. The method of claim 11, wherein said cutting and threading are carried out by a one-piece dental implant comprising a sharp threaded shaft having a sharp tip portion at its distal end, said sharp tip portion operating as an engaging member to cut through the bone and to define a path to said implant, thereby enabling in site reshaping of the dental implant for aligning it with an existing teeth or additional implants.

15. The method of claim 11, wherein said cutting and threading create an in-bone space by lateral bone compression.

16. A method of inserting a dental implant into a natural jaw bone of a patient, said method comprising:
a. providing a dental implant according to claim 1;
b. engaging a tool fitting the head of said dental implant;
c. rotating said tool to insert said dental implant into the jaw bone of a patient.

17. The method according to claim 16 further comprising attaching a prosthetic tooth to said dental implant.

18. The method according to claim 16 wherein said attaching involves immediate loading.

19. The method according to claim 16 further comprising putting in correspondence the prosthetic axis with the local situation.
